(19) United States
(12) Patent Application Publication
(10) Pub. No.: US 2008/0200175 A1
(43) Pub. Date: Aug. 21, 2008

(54) Method For Optimizing the Positioning of High Sensitivity Receiver Front-Ends in a Mobile Telephony Network and Related Mobile Telephony Network

(76) Inventors: Vincenzo Boffa, Milano (IT); Eraldo Damosso, Torino (IT); Enrico Giovanardi, Torino (IT); Renata Mele, Milano (IT); Fabrizio Ricci, Milano (IT); Loris Stola, Torino (IT); Daniela Tealdi, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/538,192

(22) PCT Filed: Dec. 10, 2002
(86) PCT No.: PCT/IB02/05216

§ 371 Date: Jul. 6, 2007

Related U.S. Application Data
(60) Provisional application No. 60/431,916, filed on Dec. 9, 2002.

(51) Int. Cl. H04Q 7/36

(52) U.S. Cl. 455/446

(57) ABSTRACT

The present invention relates to a method for optimizing the positioning of high sensitivity receiver front-ends 5 in a mobile telephony network 1 of the CDMA type comprising a plurality of cells 2. The method comprises the following steps: defining a first and a second cell indicator V_{cell}, V₂; defining a first and a second threshold value L and L₂; comparing said first cell indicator V_{cell} with a first threshold value L and said second cell indicator V₂ with a second threshold value L₂; associating with a first category a plurality of first cells 2a having said first cell indicator V_{cell} greater than said first threshold value L or said second cell indicator V₂ greater than said second threshold value L₂; positioning a plurality of high sensitivity receiver front-ends 5 substantially in all said plurality of first cells 2a. The method further comprises the steps of: associating with a second category a plurality of second cells 2b having said first cell indicator V_{cell} smaller than said first threshold value L and said second cell indicator V₂ smaller than said second threshold value L₂; positioning a plurality of low sensitivity receiver front-ends substantially in all said plurality of second cells 2b.

The present invention generally relates to the field of mobile telephony and particularly to a mobile telephony network with access of the CDMA type (“Code Division Multiple Access”), hence W-CDMA or CDMA 2000 or UMTS. More particularly, the present invention relates to a method for optimizing the positioning of high sensitivity receiver front-ends in a mobile telephony network and to a related mobile telephony network.

In a mobile telephony network, geographic areas are subdivided into a plurality of cells. The network traffic in each cell is handled by a Base Transceiver Station for transmitting and/or receiving radio signals (voice and/or data) to/from mobile terminals. Such base transceiver stations can be equipped with receiver front-ends inserted downstream of a transceiver antenna, whose main function is to select and amplify the radio signals that are within the frequency range useful for communication and to attenuate all other potentially interfering signals.

Typically, communication from the mobile terminal to the base transceiver station (up-link channel) is characterized by radio signals having rather low power. Such radio signals are therefore subject to degradation in the presence of noise.

As disclosed in U.S. Pat. No. 6,263,215, in order to increase significantly the signal-to-noise ratio and hence the sensitivity of base transceiver stations in receiving the radio signals transmitted by the mobile terminals, the stations can be equipped with cryogenic receiver front-ends.

As described in M. I. Salkola “CDMA Capacity—Can You Supersize That?”, 2002 IEEE Wireless Communications and Networking Conference Record. WCNC 2002 (Cat. No. 02TH8609) vol. 2 pp. 768-73, the application of cryogenic receiver front-ends to the base transceiver stations has a direct impact on the performance of the mobile telephony network because it makes it possible to increase its capacity.

Moreover, as described in D. Jedamzik; R. Menolascino; M. Pizarroso; B. Salas; “Evaluation of HTS sub-systems for cellular base stations” 1999 IEEE Transactions on Applied Superconductivity” vol. 9 no. 2 pt. 3 pp. 4022-5, there are two scenarios where an operator, in the case of a GSM-type network, can find interesting the characteristics of base transceiver stations equipped with front-ends made with superconducting materials. These two scenarios correspond to a coverage-limited scenario (low traffic cases where coverage is the limiting factor) and a capacity-limited scenario (high traffic environment where the offered traffic is the limiting factor). The coverage-limited scenario corresponds to a rural environment, where the greater sensitivity of base transceiver stations equipped with front-ends made with superconducting materials makes it possible to obtain an expansion of the coverage area of individual cells. The capacity-limited scenario corresponds to an urban environment, where the base transceiver station equipped with front-ends made with superconducting materials would allow a tighter frequency reuse as a result of the better isolation between carries it provides.

For each of these two scenarios, two network designs are produced and analyzed in a comparative manner. The first network design is totally composed of standard base transceiver stations and the second network design is totally composed of base transceiver stations equipped with front-ends made with superconducting materials.

Results are presented for a GSM-1800 type network. In particular, these results show that the network operator can choose to employ different advantages; for example a reduction in the number of base transceiver stations in rural areas by 24% or an increased capacity in urban areas, with a simultaneous reduction of carriers by 30%.

However, the aforementioned paper fails to provide a well defined meaning for the terms “urban” and “rural”.

Moreover, the Applicant has observed that the advantages listed in the paper, in particular for the urban area, are connected to the improved spectral selectivity of base transceiver stations equipped with front ends made with superconducting material with respect to standard base transceiver stations. An improved spectral selectivity is particularly significant in the case of a GSM network.

In the remainder of the present description and claims we shall define as high sensitivity receiver front-end a front end having a total noise figure of less than 2 dB, more preferably less than 1 dB, still more preferably less than 0.7 dB. Preferably, the high sensitivity receiver front-end is mounted a short distance from the transceiver antenna. Preferably, the high sensitivity receiver front-end comprises at least a filter and an amplifier mutually connected in cascade arrangement. Preferably, the filter and the amplifier operate at cryogenic temperatures. The filter preferably comprises superconducting materials.

The Applicant, however, has observed that if an operator has a number of high sensitivity receiver front-ends that is lower than the number of cells into which the mobile telephony network is subdivided, the operator must be able to select a criterion for positioning said receiver front-ends in such a way as to maximize network performance.

Advantageously, the Applicant has found that according to a criterion for positioning a smaller number of high sensitivity receiver front-ends than the number of cells into which a network is subdivided, in such a way as to maximize the performance of the network itself, each cell of the network is preferably assigned a first or a second category, based on a traffic expectation constructed from cartographic/morphological information so that the number of first category cells is approximately equal to the number of high sensitivity receiver front-ends. The Applicant has also observed that by positioning the high sensitivity receiver front-ends available to the operator substantially in all cells belonging to the first category, the traffic collected by the network can be maximized.

More specifically, a method for optimizing the positioning of high sensitivity receiver front-ends within a mobile telephony network 1 of the CDMA type comprising a plurality of cells 2, includes the steps of: defining a first and a second cell indicator V_{cell}, V₂; defining a first and a second threshold value L and L₂; comparing said first cell indicator V_{cell} with a first threshold value L and said second cell indicator V₂ with a second threshold value L₂; associating with a first category a plurality of first cells 2a, each of said first cells 2a having said first cell indicator V_{cell} greater than said first threshold value L or said second cell indicator V₂ greater than said second threshold value L₂; positioning a plurality of high sensitivity receiver front-ends 5 substantially in all said plurality of first cells 2a.

The method according to the invention can further comprise the steps of: associating with a second category a plurality of second cells 2b, each of said second cells 2b having said first cell indicator V_{cell} smaller than said first threshold value L and said second cell indicator V₂ smaller than said second threshold value L₂; positioning a plurality of low sensitivity receiver front-ends substantially in all said plurality of second cells 2b.

Advantageously, the step of defining for each cell 2 a first and a second cell indicator V_{cell}, V₂ comprises the steps of: associating with said first cell indicator V_{cell} cartographic/morphological characteristics indicative of a traffic expectation for each cell 2; associating with said second cell indicator V₂ cartographic/morphological characteristics indicative of a traffic expectation for each cell 2 and of an expanse of geographic area whereon each cell 2 stands.

Moreover, the step of defining a first and a second threshold value L and L₂ comprises the step of selecting a pair of values for said first and second threshold value L and L₂ in such a way that said plurality of first cells 2a is substantially equal in number to said plurality of high sensitivity receiver front-ends 5 and that said plurality of second cells 2b is substantially equal to the difference between said plurality of cells 2 and said plurality of first cells 2a.

Advantageously, said pair of values comprises a first and a second value that meet the condition whereby the ratio between said first value and said second value is roughly equal to 1/15±0.005.

Another aspect of the present invention relates to a CDMA mobile telephony network 1 comprising a plurality of cells 2. The plurality of cells 2 includes a plurality of first cells 2a associated to at least 90% of a plurality of high sensitivity receiver front-ends 5, each first cell 2a having a first cell indicator V_{cell} greater than a first threshold value L or a second cell indicator V₂ greater than a second threshold value.

Moreover, the mobile telephony network 1 according to the invention comprises a plurality of second cells 2b associated to a plurality of low sensitivity receiver front-ends, each second cell 2b having said first cell indicator V_{cell} smaller than said first threshold value L and said second cell indicator V₂ smaller than said second threshold value L₂.

Advantageously, the first cell indicator V_{cell} is associated to cartographic/morphological characteristics indicative of a traffic expectation for each cell 2 while the second cell indicator V₂ is associated to cartographic/morphological characteristics indicative of a traffic expectation for each cell 2 and of an expanse of geographic area whereon each cell 2 stands.

Furthermore, each high sensitivity receiver front-end 5 is inserted between a transceiver antenna 4 and a base transceiver station 3.

In a preferred embodiment, the high sensitivity receiver front-end 5 is a cryogenic receiver front-end.

In detail, the cryogenic receiver front-end comprises a cryostat 11 that encloses at least a band-pass type filter 12 and a low noise amplifier 13. Preferably, the band-pass filter 12 is obtained with a technology based on high critical temperature superconducting materials.

According to an additional aspect of the present invention, each high sensitivity receiver front-end 5 is inserted between a transceiver antenna 4 and a base transceiver station 3, said high sensitivity receiver front-end 5 comprising at least a first and a second band-pass filter 25, 26 between which is inserted a low noise amplifier 27.

The cryogenic receiver front-end 5 can be mounted along the antenna lead-in in such a way as to minimize the overall noise figure of the receiver chain.

More preferably, the cryogenic receiver front-end 5 is mounted at such a distance that losses due to antenna lead-in are negligible with respect to the noise figure introduced by the cryogenic receiver front-end 5.

Preferably, said cryostat 11 operates at cryogenic temperatures lower than 200 K, more preferably lower than 100 K.

Moreover, preferably, the cryostat 10 operates at cryogenic temperatures higher than 60 K.

In particular, the number of the plurality of cells 2 that form the mobile telephony network 1 is greater than a predetermined value.

Preferably, said predetermined value is greater than 100, more preferably it is greater than 500, yet more preferably it is greater than 1000.

The characteristics and advantages of the present invention shall become more readily apparent from the description, set out hereafter, of an embodiment provided purely by way of non limiting example with reference to the accompanying drawings, in which:

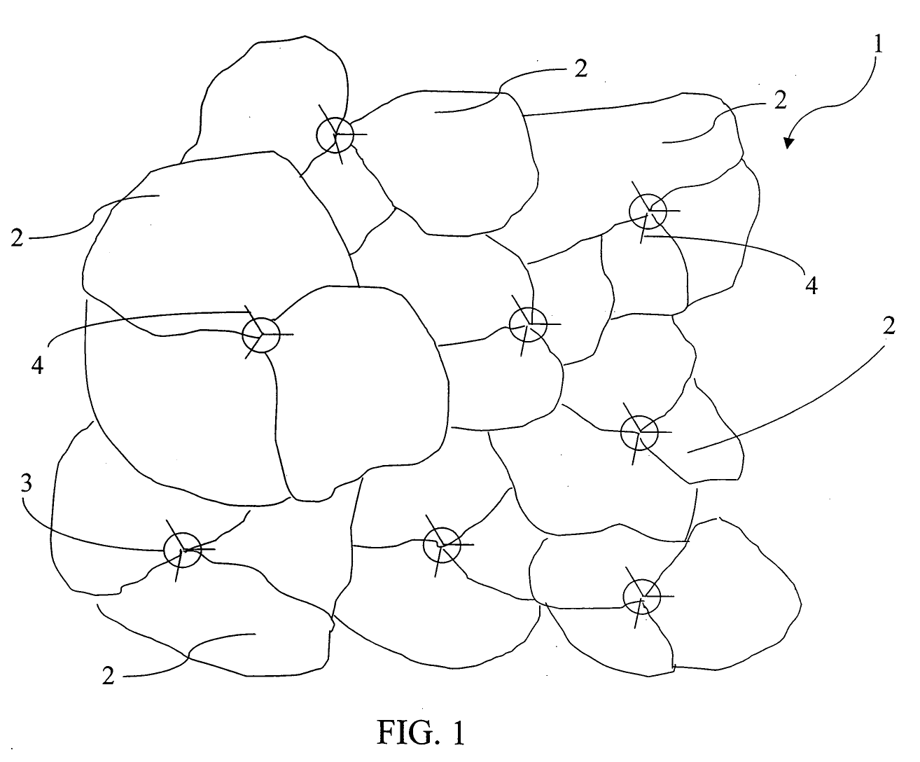

FIG. 1 is a schematic representation of a best server portion of a W-CDMA mobile telephony network;

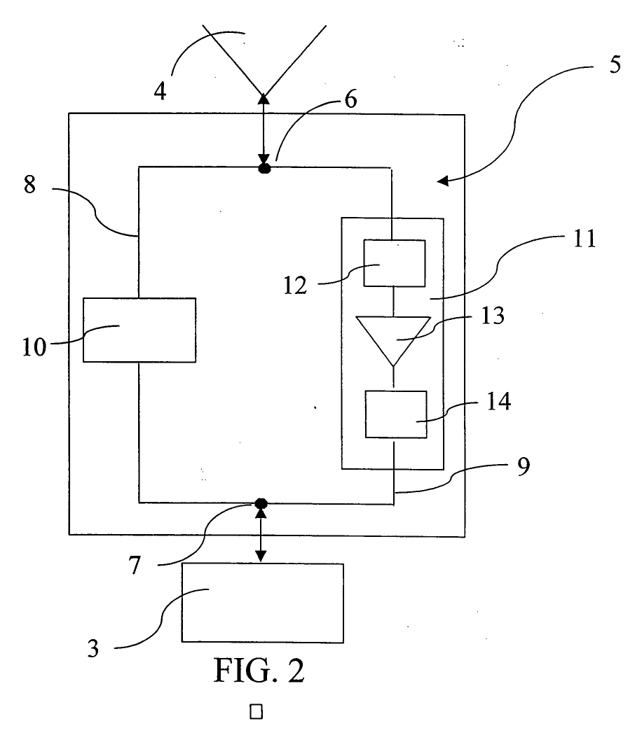

FIG. 2 is a schematic representation of a preferred embodiment of a high sensitivity receiver front-end for use in the network of FIG. 1; and

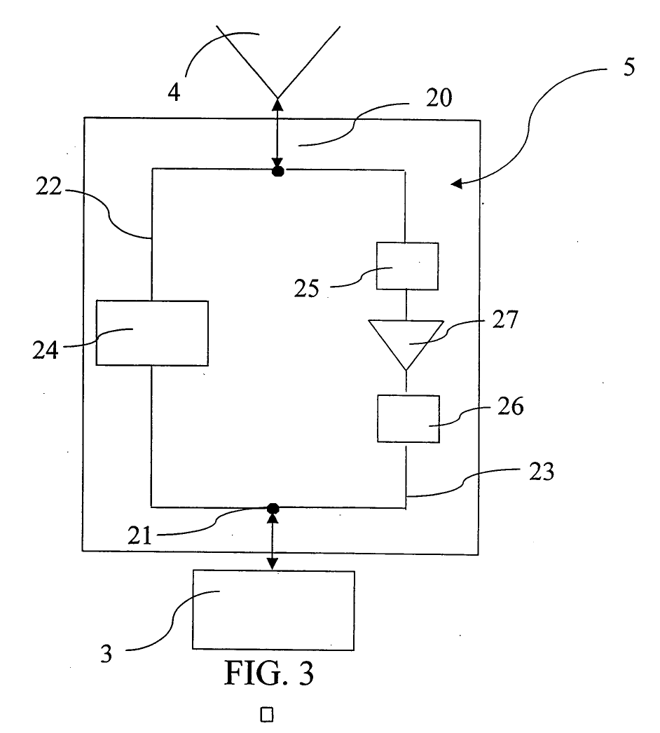

FIG. 3 is a schematic representation of an additional embodiment of a high sensitivity receiver front-end used in the network of FIG. 1;

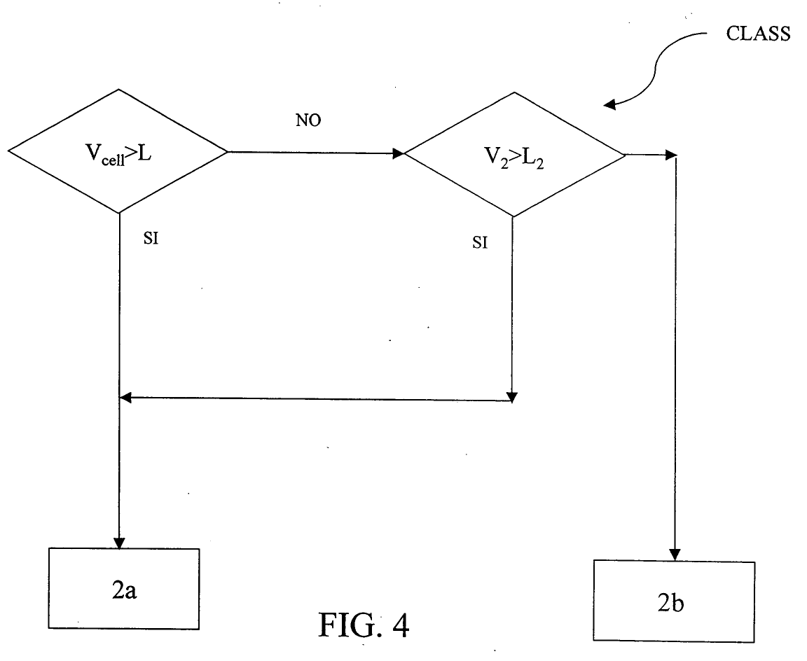

FIG. 4 shows a flow chart relating to the implementation of the method according to the invention.

With reference to FIG. 1, the method for optimizing the positioning of high sensitivity receiver front-ends in a mobile telephony network according to the invention is applied to a mobile telephony network 1, or to a portion thereof, with access of the CDMA type, and in particular of the W-CDMA or CDMA 2000 or UMTS type. For the sake of simplicity, FIG. 1 does not show the so-called soft handover areas, because they are not essential for the purposes of the present invention. In particular, the term soft handover area means the area in which a mobile terminal simultaneously maintains active connections with more than one cell.

More in detail, the mobile telephony network 1 comprises a plurality of cells 2 (for instance more than 100, preferably more than 500 and yet more preferably more than 1000). The network traffic present in each cell 2 is handled by a base transceiver station 3 (or B-node) for transmitting and/or receiving radio signals (voice and/or data) to/from mobile terminals, such as cellular telephones, PDAs, computers, etc. The base transceiver station 3 comprises a number of transceiver antennas 4 equal to the number of cells 2 that the station is to serve.

In the mobile telephony network 1 it is advantageous for the operator to be able to position a number of high sensitivity receiver front-ends smaller than the plurality of cells 2, in order to maximize the performance of the network.

As FIG. 2 shows, a high sensitivity receiver front-end 5 is typically inserted between a transceiver antenna 4 and the base transceiver station 3. More specifically, a receiver front-end is defined as having high sensitivity if the overall noise figure of the receiver chain from the transceiver antenna 4 to the base transceiver station 3 is less than 2 dB, more preferably less than 1 dB, yet more preferably less than 0.7 dB. In a preferred embodiment, the high sensitivity receiver front-end 5 comprises one or more devices operating at cryogenic temperatures. In this case, the high sensitivity receiver front-end 5 will be indicated as cryogenic receiver front-end. In detail, the cryogenic receiver front-end 5 comprises a first node 6 coupled to the transceiver antenna 4 and a second node 7 coupled to the base transceiver station 3. In detail, in the first node 6 the signal coming from the transceiver antenna 4 is split into two distinct signals, a transmission signal and a reception signal. In the second node 7 the two transmission and reception signals present at the end of the two chains of transmission and reception are rejoined. The resulting signal is then sent to the base transceiver station 3. Between the first and the second node 6, 7 are inserted a transmission branch 8 in which the transmission signal passes and a reception branch 9 in which the reception signal passes. The transmission branch 8 comprises a transmission filter 10 while the reception branch 9 comprises a cryostat 11 that encloses a band-pass filter 12 and a low noise amplifier (LNA) 13, mutually connected in cascade arrangement. Preferably, the cryostat 11 comprises an additional band-pass filter 14. Alternatively, the band-pass filter 14 can be positioned outside the cryostat 11. Preferably, the band-pass filter 12 and the additional band-pass filter 14 are constructed with a technology based on High critical Temperature Superconductors (HTS). Moreover, the cryostat 11 operates at cryogenic temperatures ranging between 60 K and 200 K and, more preferably, between 60 K and 100 K.

The cryogenic receiver front-end 5 is preferably mounted at such a distance from the transceiver antenna 4 that the losses due to the antenna lead-in are negligible relative to the noise figure introduced by the receiver front-end itself. Preferably, said distance is no greater than 1 m. Less preferably, the cryogenic receiver front-end 5 can be placed in the most accessible position along the antenna lead-in in such a way as to reduce in any case the overall noise figure of the receiver chain.

More in detail, a cryogenic receiver front-end and the process for its manufacturing are described in US patent application 2002053215.

Advantageously, cryogenic receiver front-ends have a reduced noise figure (no more than 2 dB, more preferably no more than 1 dB, yet more preferably no more than 0.7 dB). By way of comparison, the noise figure of traditional base transceiver stations usually exceed 2.5 dB.

All this translates into an increase of from 1 dB to 10 dB of the sensitivity of the base transceiver station 3 with respect to the sensitivity of traditional base transceiver stations.

In a less preferred embodiment, shown in FIG. 3, the high sensitivity receiver front-end 5 (where the term “high sensitivity” in this case means a noise figure of less than 2 dB and more preferably less than 1.5 dB) is mounted at a short distance from the transceiver antenna 4 in order to avoid losses due to antenna lead-in (Tower Mounted Amplifier or TMA). The high sensitivity receiver front-end 5 comprises a first node 20 coupled to the transceiver antenna 4 and a second to node 21 coupled to the base transceiver station 3. In the first node 20 the signal coming from the transceiver antenna 4 is split into two distinct signals, a transmission signal and a reception signal. The second node 21 rejoins the transmission and the reception signals present at the end of the two chains of transmission and reception. The resulting signal is then sent to the base transceiver station 3. Between the first and the second node 20, 21 are inserted a transmission branch 22 and a reception branch 23. The transmission branch 22 comprises a transmission filter 24 while the reception branch 23 comprises a first and a second band-pass filter 25, 26 of a traditional type, between which is inserted a low noise amplifier 27 not operating at cryogenic temperatures.

The method according to the invention will now be described with reference to the flow chart shown in FIG. 4. In detail, the flow chart of FIG. 4 represents a classification algorithm CLASS that operates a classification at the level of the individual cells 2. Each cell 2 is defined as the set of pixels (elements of territory, typically having dimensions in the order of 50 m×50 m) which, for a particular type of service provided by the mobile telephony network 1, constitute the best server area of the transceiver antenna 4 serving that cell. In particular, the term “best server area” means the location of the pixels in which the transceiver antenna 4 guarantees a field level necessary (electromagnetic requirement) for the delivery of that particular type of service and greater than the field level provided by any other bordering transceiver antenna.

It is important to note that the classification algorithm CLASS makes use of a pixel weighting factor ρₚ which can assume a finite number of values (by way of indication, between 1 and 100) based on cartographic/morphological information.

For each pixel, one has:

ρₚ=MAX(ρ_{d},ρₘ,ρₛ)

where:
ρ_{d} is a factor that takes into account the built-up percentage of the pixel (i.e. the percentage of the surface of the pixel covered by constructions having a height exceeding 3 m) and it can assume, by way of indication, values included in the range 1-100;
ρₘ is a factor that takes into account the morphology of the pixel and it can assume, by way of indication, the values shown in table 1, set out below:

TABLE 1

| Type of environment | Value of factor ρₘ |
|---|---|
| Urban | 20 |
| Suburban | 15 |
| Industrial area | 10 |
| Thickly wooded area | 1 |
| Thinly wooded area and meadow with trees | 2 |
| Open area with vegetation and damp areas | 2 |
| Bare area | 1 |
| Glacier | 1 |
| Water | 2 |

It is important to specify that, in this context, an environment is considered urban when buildings, roads, and artificially covered surfaces (buildings whose height is less than or equal to 3 m, parking lots, courtyards, streets, etc.) occupy more than 80% of the total surface considered. On the other hand, an environment is considered suburban when buildings, roads, and artificially covered surfaces (low buildings, parking lots, etc.) occupy between 50% and 80% of the total surface.

Additionally, ρₛ is a factor that takes into account the presence of communication infrastructures such as railroads, highways and thoroughfares and it can assume, by way of indication, the values shown in table 2 set out below:

TABLE 2

| Starting data item | Value of ρₛ |
|---|---|
| Highway | 60 |
| Highway + thoroughfare | |
| Highway + thoroughfare + railroad | |
| Thoroughfare | 30 |
| Thoroughfare + railroad | |
| Railroad | 20 |

For each cell 2 the Applicant has defined the following dimensions:

Nₚ=number of pixels that make up an individual cell 2 (area of the individual cell 2);
ρₚᵢ=value assumed by the pixel weighting factor ρₚ;
Nₚ(ρₚᵢ)=number of pixels for which the pixel weighting factor ρₚ assumes the value ρₚᵢ.

Starting from the above dimensions, the Applicant has subsequently defined a first and a second cell indicator, respectively V_{cell} and V₂, represented by the following expressions:

$$\begin{matrix}{V}_{cell} = \frac{1}{{N}_{p}} {\sum }_{i = 1}^{100} {ρ}_{pi} {N}_{p} ( {ρ}_{pi} ) \\ {V}_{2} = \frac{1}{100} {\sum }_{i = 3}^{100} {ρ}_{pi} {N}_{p} ( {ρ}_{pi} )\end{matrix}$$

where the first cell indicator V_{cell} provides an evaluation normalized to the area of the value of the cell 2 considered in terms of factor ρₚ and indicatively it can assume values within the 1-100 range, while the second cell indicator V₂ considers in absolute sense, i.e. wholly independently from the dimensions of the area, only the values of the factor ρₚ that exceed 2. The Applicant has observed that values of the factor ρₚ that are smaller than or equal to 2 distinguish pixels with a low level of interest in terms of traffic potentially offered. The range of values assumed by this second cell indicator V₂, in the absence of normalization, cannot be defined a priori (except for the minimum value, which is 3).

The Applicant has also observed that high values of the first cell indicator V_{cell} (in particular greater than or equal to 20) are associated to cells 2 with high presence of elements that distinguish an urban territory or with cells 2 with morphological characteristics (highways, thoroughfares, railroads) that are comparable in terms of traffic potentially offered (and hence, of traffic to be handled). However, normalization to the area tends to lower the value of the first cell indicator V_{cell} associated to the cells 2 which, while including some pixels with typically urban characteristics, have a rather extensive area, typical of substantially open areas.

The Applicant has thus introduced the second cell indicator V₂, through which values are assigned to the cells 2 that extend mainly on open areas but also include areas with small towns or segments of roads or railroads.

The Applicant has also observed that the combined use of these two cell indicators V_{cell} and V₂ assures an adequate classification of the cells 2.

With reference again to the flow chart of FIG. 4, the classification algorithm CLASS assigns to the cells 2 preferably a first and a second category.

In particular, the first category comprises a plurality of first cells 2a having the first cell indicator V_{cell} greater than a first threshold value L or the second cell indicator V₂ greater than a second threshold value L₂, while the second category comprises a plurality of second cells 2b having the first cell indicator V_{cell} smaller than the first threshold value L and the second cell indicator V₂ smaller than the second threshold value L₂.

The Applicant has observed that the first and the second threshold value L and L₂ can preferably be chosen from any pair of values that meets the following condition:

$$\frac{L}{{L}_{2}} ≅ \frac{1}{1 \; 5} \pm 0.005$$

The optimal pair of values will be the one for which the plurality of first cells 2a is substantially equal (where the term “substantially” means more or less 10%) to the plurality of high sensitivity receiver front-ends 5 available to the operator. Consequently, the plurality of second cells 2b will be substantially equal (where the term “substantially” means more or less 10%) to the difference between the plurality of cells 2 that compose the mobile telephony network 1 and the plurality of first cells 2a.

According to the method of the present invention, at least 90% of the plurality of high sensitivity receiver front-ends 5 available to the operator is then associated to the plurality of first cells 2a belonging to the first category while the plurality of second cells 2b of the second category is equipped with low sensitivity receiver front-ends, where the term “low sensitivity” means that the overall noise figure exceeds 2.5 dB.

Hereafter, the performance of the mobile telephony network 1 is analyzed in terms of offered traffic recovered (as a function of the expansion of the best server area) using the method according to the invention.

To perform this analysis, the Applicant considered a mobile telephony network 1 able to cover a portion of the Italian territory. The considered network comprised a number of cells 2 equal to 2171. The Applicant, moreover, hypothesized that the number of high sensitivity receiver front-ends 5 available to the operator was equal to 1208.

With regard to the geographic area examined, two distinct portions of the territory were identified: the first one refers to a portion of territory around a city and the second one refers to a portion of territory not including any cities.

The electromagnetic parameters (frequency, power, antenna) in use are those of the UMTS standard

The Applicant then selected for the threshold values L and L₂ the pair of values (10, 150). Using this pair of values (10, 150) a subdivision of the 2171 cells 2 is achieved that assigns to the first category a number of first cells 2a equal to 1208 (hence, equal to the number of high sensitivity receiver front-ends 5 available to the operator) and to the second category a number of second cells 2b equal to 963.

According to the method of the present invention, the 1208 first cells 2a are then equipped with the high sensitivity receiver front-ends 5 (in this case, the term “high sensitivity” means a noise figure of 0.7 dB) whilst the 963 second cells 2b are equipped with low sensitivity receiver front-ends (in this case, “low sensitivity” means a noise figure of 2.7 dB). The results obtained in terms of offered traffic are shown in column 1 of table 3, set out below.

### Offered Traffic (Erl)

TABLE 3

| Level of | High sensitivity receiver | | |
|---|---|---|---|
| electromagnetic | front-ends 5 in the 1208 | High sensitivity receiver | High sensitivity receiver |
| field | cells 2 belonging to the | front-ends 5 in 405 urban | front-ends 5 in 405 rural |
| dBμV/m | first category | sites (1188 cells) | sites (983 cells) |
| 41 | 29980 | 29857 | 29973 |
| 49 | 27668 | 27465 | 27562 |
| 57 | 23107 | 22867 | 22427 |
| 61 | 19502 | 19270 | 18544 |
| 67 | 13499 | 13367 | 12579 |

It should be noted that the offered traffic is measured in Erlangs. In detail, the Erlang is the measure of the mean daily traffic intensity which in terms of offered traffic corresponds to the mean number of potential connections simultaneously active.

Moreover, the offered traffic was calculated for best server areas referred to five different types of service corresponding to five different levels of electromagnetic field, set out below:
41 dBμV/m Voice 13 kb/s with earphone;
49 dBμV/m Voice 13 kb/s without earphone/in car with earphone;
57 dBμV/m Data 144 kb/s in car;
61 dBμV/m Data 64 kb/s indoors;
67 dBμV/m Data 384 kb/s indoors.

Columns 2 and 3 of Table 3 instead show the results obtained by applying to the mobile telephony network 1a classification algorithm that operates at site level (site being defined as the location of the pixels served by a single base transceiver station 3) and not at the level of individual cells 2 as is instead the case for the classification algorithm CLASS. In particular, the sites are classified as urban sites and rural sites.

Operating on the same geographic area defined previously, the classification of “urban” was assigned to all 405 sites, corresponding to a number of cells 2 equal to 1188, that are located within the portion of territory around the city and that of “rural” to the remaining 405 sites, corresponding to a number of cells 2 equal to 983, of the portion of territory not including cities.

The results shown in column 2 of Table 3 relate to the case in which all 405 urban sites (i.e. all 1188 cells 2) are equipped with the high sensitivity receiver front-ends 4 whilst the 405 rural sites (i.e. all 983 cells 2) are equipped with the low sensitivity receiver front-ends.

The results shown in column 3 of Table 3 instead relate to the case in which all 405 rural sites are equipped with the high sensitivity receiver front-ends 4 whilst all 405 urban sites are equipped with the low sensitivity receiver front-ends.

As can be observed comparing the columns of Table 3, the increase in terms of offered traffic obtained using the method according to the invention depends on the field level considered. Comparing columns 1 and 2 of table 3, the increase in terms of monthly Erlangs ranges from a minimum of 123 Erl for the field level of 41 dBμV/m to a maximum of 240 Erl for the field level of 57 dBμV/m.

On the other hand, comparing columns 1 and 3 of table 3, the increase in terms of offered traffic obtained using the method according to the invention ranges from a minimum of 7 Erl for the field level of 41 dBμV/m to a maximum of 958 Erl for the field level of 61 dBμV/m.

In general, it can be stated that by applying the method according to the invention to the mobile telephony network 1 an increase in the traffic offered by the entire network is obtained and hence an increase in the capacity of the network that ranges from a minimum of 7 Erl to a maximum of 958 Erl.

The Applicant has determined that the increase in offered traffic is maintained substantially stable even varying by ±10% the pair of threshold values L and L₂ and/or equipping with the high sensitivity receiver front-ends 4 at least 90% of the plurality of first cells 2a.

Moreover, it is important to specify that the increase in terms of offered traffic was obtained using a band-pass filter 12 having a bandwidth of about 60 MHz. This means that the advantages highlighted herein are not linked to the improved spectral selectivity of the base transceiver stations as stated by Jedamzik et al. in particular for the urban area. An improved spectral selectivity is particularly significant in the case of a GSM network, like the one used for the simulations described in the article, where it is important to reduce interference due to the adjacent channels. In the case of a network of the CDMA type, and in particular of the UMTS type, like the mobile telephony network according to the invention, the advantages described above in terms of offered traffic are independent and additional with respect to any advantages deriving from the reduction of the interference due to the adjacent channels. In the example of the network 1 described, any adjacent channels are not eliminated by the band-pass filter 12.

The Applicant has also conducted an additional analysis in which the portion of mobile telephony network 1 considered comprised a number of cells 2 equal to 1188. In particular, the geographic area examined corresponds to a portion of territory around a city. The Applicant has also hypothesized that the operator had available a number of high sensitivity receiver front-ends 4 equal to 10% or to 50% or to 80% of the total number of cells 2 considered, i.e. equal to 119, 594 and 950 respectively. For each of the configurations considered, the Applicant then identified a pair of threshold values L and L) as shown in Table 4 set out below:

TABLE 4

| | First | Second | Third |
|---|---|---|---|
| | configuration | configuration | configuration |
| Threshold Values | (10% - 119) | (50% - 594) | (80% - 950) |
| L | 41.8 | 21.2 | 10.8 |
| L₂ | 627 | 318 | 162 |

In particular, using the pair of values (41.8; 627), a subdivision of the 1188 cells 2 is reached that assigns to the first category a number of first cells 2a equal to 119 (hence equal to the number of high sensitivity receiver front-ends 5 available to the operator in this first configuration); using the pair of values (21.2; 318), a subdivision of the 1188 cells 2 is reached that assigns to the first category a number of first cells 2a equal to 594 (equal to the number of high sensitivity receiver front-ends 4 available to the operator in this second configuration); using the pair of values (10.8; 162) a subdivision of the 1188 cells 2 is reached that assigns to the first category a number of first cells 2a equal to 950 (equal to the number of high sensitivity receiver front-ends 5 available to the operator in this third configuration).

According to the method of the present invention, in the first configuration the 119 first cells 2a identified are then equipped with the high sensitivity receiver front-ends 5 available while the remaining 1069 second cells 2b are equipped with low sensitivity receiver front-ends; in the second configuration, the 594 first cells 2a identified are equipped with the available high sensitivity receiver front-ends 4 while the 594 second cells 2b are equipped with low sensitivity receiver front-ends; in the third configuration, the 950 first cells 2a identified are equipped with the high sensitivity receiver front-ends 4 available while the 238 second cells 2b are equipped with low sensitivity receiver front-ends.

It should be specified that the noise figure values for the high sensitivity receiver front-ends 5 and the low sensitivity receiver front-ends are the same as those used for the previously analyzed case.

The results obtained in terms of offered traffic are shown in Table 5 set out below; the offered traffic was calculated for the five different types of service corresponding to the five different levels of electromagnetic field considered previously.

The comparison was conducted with the case in which all 1188 cells 2 are equipped with low sensitivity receiver front ends (column 1) and with the case in which all 1188 cells 2 are equipped with high sensitivity receiver front-ends (column 5).

TABLE 5
Offered traffic (Erl)

| | 1188 cells 2 | 119 cells 2 | 594 cells 2 | 950 cells 2 | 1188 cells 2 |
|---|---|---|---|---|---|
| Level of | equipped with | equipped with | equipped with | equipped with | equipped with |
| electromagnetic | low sensitivity | high sensitivity | high sensitivity | high sensitivity | high sensitivity |
| field | receiver front- | receiver front- | receiver front- | receiver front- | receiver front- |
| dBμV/m | ends | ends | ends | ends | ends |
| 41 | 20032 | 20042 | 20085 | 20150 | 20182 |
| 49 | 18951 | 18981 | 19099 | 19243 | 19314 |
| 57 | 15922 | 16097 | 16601 | 16882 | 16992 |
| 61 | 13287 | 13530 | 14191 | 14520 | 14637 |
| 67 | 9096 | 9317 | 9948 | 10284 | 10415 |

Comparing column 1 with columns 2, 3, 4, and 5, one notes that for the first two levels of electromagnetic field, the increase in offered traffic obtained with the configurations 10%, 50%, 80% with respect to the gain in offered traffic obtained with the configuration in which all cells 2 are equipped with high sensitivity receiver front-ends is smaller than the percentage of high sensitivity receiver front-ends used.

In particular, for the level 41 dBμV/m, with 10% of high sensitivity receiver front-ends installed the gain is 10 Erl corresponding only to 6.6% of the 150 Erl gained by equipping all 1188 cells 2 with high sensitivity receiver front-ends. Vice versa for high field levels (corresponding to high-value service types) this situation is definitely inverted. In particular for the level 67 dBμV/m, with 10% of high sensitivity receiver front-ends installed, the gain is already 16% of what would be obtained equipping all 1188 cells 2 with high sensitivity receiver front-ends.

Moreover, Table 6 shows the results obtained in terms of mean recovered offered traffic (in Erlangs) per installed high sensitivity receiver front-end.

TABLE 6
Mean recovered offered traffic (Erl)

| | 1188 cells 2 | 119 cells 2 | 594 cells 2 | 950 cells 2 | 1188 cells 2 |
|---|---|---|---|---|---|
| Level of | equipped with | equipped with | equipped with | equipped with | equipped with |
| electromagnetic | low sensitivity | high sensitivity | high sensitivity | high sensitivity | high sensitivity |
| field | receiver front- | receiver front- | receiver front- | receiver front- | receiver front- |
| dBμV/m | ends | ends | ends | ends | ends |
| 41 | 0 | 0.080 | 0.089 | 0.124 | 0.126 |
| 49 | 0 | 0.250 | 0.249 | 0.307 | 0.306 |
| 57 | 0 | 1.471 | 1.143 | 1.010 | 0.901 |
| 61 | 0 | 2.047 | 1.523 | 1.299 | 1.137 |
| 67 | 0 | 1.857 | 1.435 | 1.251 | 1.111 |

The data provided in Table 6 show that for high field levels the mean traffic recovered per installed receiver front-end increases for configurations 10, 50, 80 with respect to the configuration with all high sensitivity receiver front-ends installed.

1-21. (canceled)

22. A method for optimizing the positioning of high sensitivity receiver front-ends in a mobile telephony network of the CDMA type comprising a plurality of cells comprising the following steps:
defining a first and a second cell indicator;
defining a first and a second threshold;
comparing said first cell indicator with a first threshold value and said second cell indicator with a second threshold value;
associating with a first category a plurality of first cells, each of said first cells having said first cell indicator greater than said first threshold value or said second cell indicator greater than said second threshold value; and
positioning a plurality of high sensitivity receiver front-ends substantially in all said plurality of first cells.

23. The method as claimed in claim 22, further comprising the steps of:
associating with a second category a plurality of second cells, each of said second cells having said first cell indicator smaller than said first threshold value and said second cell indicator smaller than said second threshold value; and
positioning a plurality of low sensitivity receiver front-ends substantially in all said plurality of second cells.

24. The method as claimed in claim 22, wherein said step of defining for each cell a first and a second cell indicator, comprises the steps of:
associating with said first cell indicator cartographic/morphological characteristics indicative of a traffic expectation for each cell; and
associating with said second cell indicator cartographic/morphological characteristics indicative of a traffic expectation for each cell and of an expanse of geographic area whereon each cell stands.

25. The method as claimed in claim 23 or 24, wherein said step of defining a first and a second threshold value comprises the step of selecting a pair of values for said first and second threshold value in such a way that said plurality of first cells is substantially equal in number to said plurality of high sensitivity receiver front-ends and said plurality of second cells is substantially equal to the difference between said plurality of cells and said plurality of first cells.

26. The method as claimed in claim 25, wherein said pair of values comprises a first and a second value, said first and second value meeting the condition whereby the ratio between said first value and said second value is roughly equal to 1/15±0.005.

27. A mobile telephony network of the CDMA type comprising a plurality of cells, said plurality of cells comprising a plurality of first cells associated to at least 90% of a plurality of high sensitivity receiver front-ends, each first cell having a first cell indicator greater than a first threshold value or a second cell indicator greater than a second threshold value.

28. The network as claimed in claim 27, comprising a plurality of second cells associated with a plurality of low sensitivity receiver front-ends, each second cell having said first cell indicator smaller than said first threshold value and said second cell indicator smaller than said second threshold value.

29. The network as claimed in claim 27, wherein said first cell indicator is associated to cartographic/morphological characteristics indicative of a traffic expectation for each cell and said second cell indicator is associated to cartographic/morphological characteristics indicative of a traffic expectation for each cell and of an expanse of geographic area whereon each cell stands.

30. The network as claimed in claim 27, wherein each high sensitivity receiver front-end is inserted between a transceiver antenna and a base transceiver station, said high sensitivity receiver front-end being a cryogenic receiver front-end.

31. The network as claimed in claim 30, wherein said cryogenic receiver front-end comprises a cryostat that encloses a band-pass filter and a low noise amplifier mutually connected in cascade arrangement.

32. The network as claimed in claim 31, wherein said band-pass filter is obtained with a technology based on high critical temperature superconducting materials.

33. The network as claimed in claim 30, wherein said cryogenic receiver front-end is mounted at such a distance from said transceiver antenna that losses due to antenna lead-in are negligible with respect to the noise figure introduced by said cryogenic receiver front-end.

34. The network as claimed in claim 30, wherein said cryogenic receiver front-end is mounted along an antenna lead-in in such a way as to minimize the overall noise figure of a receiver chain from said transceiver antenna to said base transceiver station.

35. The network as claimed in claim 31, wherein said cryostat operates at cryogenic temperatures lower than 200° K.

36. The network as claimed in claim 31, wherein said cryostat operates at cryogenic temperatures lower than 100° K.

37. The network as claimed in claim 31, wherein said cryostat operates at cryogenic temperatures higher than 60° K.

38. A method as claimed in claim 22, wherein each high sensitivity receiver front-end is inserted between a transceiver antenna and a base transceiver station said high sensitivity receiver front-end comprising at least a first and a second band-pass filter between which is inserted a low noise amplifier.

39. The network as claimed in claim 27, wherein said plurality of cells is greater than a predetermined value.

40. The network as claimed in claim 39, wherein said predetermined value is greater than 100.

41. The network as claimed in claim 39, wherein said predetermined value is greater than 1000.

42. The network as claimed in claim 39, wherein said predetermined value is greater than 500.
